(19) United States
(12) Patent Application Publication
(10) Pub. No.: US 2013/0319589 A1
(43) Pub. Date: Dec. 5, 2013

(54) PNEUMATIC TIRE

(71) Applicant: Sumitomo Rubber Industries, Ltd., Kobe-shi (JP)

(72) Inventor: Daisuke SATO, Kobe-shi (JP)

(73) Assignee: Sumitomo Rubber Industries, Ltd., Kobe-shi (JP)

(21) Appl. No.: 13/906,501

(22) Filed: May 31, 2013

(30) Foreign Application Priority Data
Jun. 1, 2012 (JP) 2012-126536

(51) Int. Cl. C08K 7/10; C08K 3/36; C08K 3/04

(52) U.S. Cl. CPC C08K 7/10; C08K 3/04; C08K 3/36
USPC 152/209.5; 524/575; 524/493; 524/572

(57) ABSTRACT

The present invention provides a pneumatic tire that has improved handling stability while maintaining good fuel economy and tensile strength or even improving these properties. The pneumatic tire includes a tread including a rubber layer formed from a rubber composition that includes: carbon black; silica; and staple fibers with an average width of 3 nm to 50 μm and an average length of 50 nm to 500 μm, the staple fibers in the rubber layer having an average orientation angle between the longitudinal direction of each staple fiber and the circumferential direction of the tire of 15° to 75°, and the staple fibers in the rubber layer including 35 to 100% of staple fibers each having an orientation angle between its longitudinal direction and the circumferential direction of the tire of 15° to 75°.

### TECHNICAL FIELD

The present invention relates to a pneumatic tire.

### BACKGROUND ART

For resource saving, energy saving, and environmental protection, social needs for reduction in carbon dioxide gas emission have recently been increasing. In the automotive field, in order to reduce carbon dioxide gas emission, various measures including weight saving of cars and use of electric energy have been considered.

Every type of car is required to have better fuel economy by improving the rolling resistance of tires, and is also increasingly desired to have enhanced safety during running and enhanced durability. Since these properties greatly depend on the performance of tires, tires for cars are increasingly desired to have improved fuel economy, wet grip performance, handing stability, and durability (e.g. tensile strength). The performance of tires depends on various factors including the structure and materials of tires, particularly the performance of the rubber composition used in the tread part which comes into contact with the road surface. For this reason, a wide range of studies have been undertaken to technically improve rubber compositions for tire components such as a tread, and these techniques have been put into practical use.

Patent Literature 1, for example, teaches a method of reducing the amount of filler and a method of utilizing a modified polymer as techniques for improving the fuel economy of rubber compositions. However, when the amount of filler is reduced or filler is highly dispersed, the stiffness of rubber is likely to be reduced, which leads to the problem of decrease in kinematic performance (e.g. handling stability) of tires.

### CITATION LIST

### Patent Literature

Patent Literature 1: JP 2000-344955 A

### SUMMARY OF INVENTION

### Technical Problem

The present invention aims to provide a pneumatic tire which solves the above problem and has improved handling stability while maintaining good fuel economy and tensile strength or even improving these properties.

### Solution to Problem

The present invention relates to a pneumatic tire, including a tread including a rubber layer formed from a rubber composition that includes: carbon black; silica; and staple fibers with an average width of 3 nm to 50 μm and an average length of 50 nm to 500 μm, the staple fibers in the rubber layer having an average orientation angle between the longitudinal direction of each staple fiber and the circumferential direction of the tire of 15° to 75°, the staple fibers in the rubber layer including 35 to 100% of staple fibers each having an orientation angle between its longitudinal direction and the circumferential direction of the tire of 15° to 75°.

The staple fibers are preferably silica rods.

The staple fibers are preferably obtained by defibration of a sepiolite mineral. Also, the staple fibers preferably have a ratio of the average length to the average width of 5 to 2000.

The rubber composition preferably includes, per 100 parts by mass of a rubber component, 5 to 150 parts by mass of the carbon black, 10 to 150 parts by mass of the silica, and 0.5 to 50 parts by mass of the staple fibers.

Preferably, the tread is obtained by stacking a rubber layer A formed from the rubber composition and a rubber layer B formed from the rubber composition, the staple fibers in the rubber layer A have an average orientation angle between the longitudinal direction of each staple fiber and the circumferential direction of the tire of 15° to 75°, and the staple fibers in the rubber layer B have an average orientation angle between the longitudinal direction of each staple fiber and the circumferential direction of the tire of −15° to −75°.

Preferably, the tread includes a rubber layer C formed from the rubber composition and a rubber layer D formed from the rubber composition, the rubber layer C and the rubber layer D are arranged next to each other in the axis direction of the tire, the length of the rubber layer C in the axis direction of the tire constitutes 20 to 80% of the length of the tread in the axis direction of the tire, the staple fibers in the rubber layer C have an average orientation angle between the longitudinal direction of each staple fiber and the circumferential direction of the tire of 15° to 75°, and the staple fibers in the rubber layer D have an average orientation angle between the longitudinal direction of each staple fiber and the circumferential direction of the tire of −15° to −75°.

The rubber layer preferably has a ratio (E*ₐ/E*_{b}) of a complex elastic modulus E*ₐ in the circumferential direction of the tire to a complex elastic modulus E*_{b} in the radial direction of the tire of lower than 5.0.

Preferably, the rubber composition includes a polymer mixture obtained by modifying a polymer of at least one of a conjugated diene compound and an aromatic vinyl compound by a compound containing at least one of an ester group and a carboxyl group, and the polymer mixture has a weight average molecular weight of 1.0×10³ to 1.0×10⁵.

Preferably, the polymer mixture contains a modified polymer containing a modifying group represented by the following formula (1):

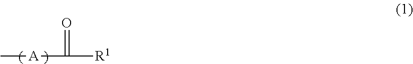

wherein A represents a divalent saturated or unsaturated hydrocarbon group; R¹ represents OR⁴ or a group represented by formula (2) below; and R⁴ represents a hydrogen atom or a monovalent saturated or unsaturated hydrocarbon group,

the formula (2) being:

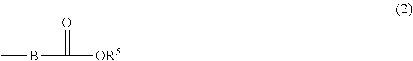

wherein B represents a divalent saturated or unsaturated hydrocarbon group, and R⁵ represents a hydrogen atom or a monovalent saturated or unsaturated hydrocarbon group.

Preferably, the A is represented by the following formula (3):

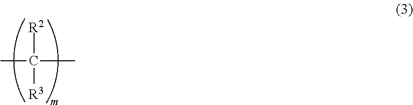

wherein m represents an integer of 0 to 6, and R² and R³ are the same as or different from each other, each representing a hydrogen atom, a C1 or C2 hydrocarbon group, or an aryl group, and

the B is represented by any one of the following formulas (4) to (7):

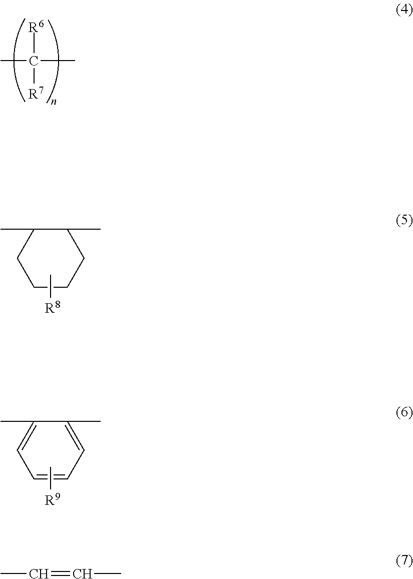

wherein n represents an integer of 2 or 3; R⁶ and R⁷ are the same as or different from each other, each representing a hydrogen atom or a C1 to C18 hydrocarbon group; R⁸ represents a hydrogen atom or a methyl group; and R⁹ represents a hydrogen atom or a C1 to C4 hydrocarbon group.

The polymer mixture preferably has a viscosity at 25° C. of 1.0×10⁴ to 8.0×10⁵.

The polymer used to form the polymer mixture is preferably a styrene homopolymer, a butadiene homopolymer, or a styrene-butadiene copolymer.

The compound containing at least one of an ester group and a carboxyl group is preferably a carboxylic anhydride.

### Advantageous Effects of Invention

The present invention can provide a pneumatic tire, including a tread including a rubber layer formed from a rubber composition that includes: carbon black; silica; and staple fibers with an average width of 3 nm to 50 μm and an average length of 50 nm to 500 μm, the staple fibers in the rubber layer having an average orientation angle between the longitudinal direction of each staple fiber and the circumferential direction of the tire of 15° to 75°, and the staple fibers in the rubber layer including 35 to 100% of staple fibers each having an orientation angle between its longitudinal direction and the circumferential direction of the tire of 15° to 75°. Such a pneumatic tire has improved handling stability while maintaining good fuel economy and tensile strength or even improving these properties.

### BRIEF DESCRIPTION OF DRAWINGS

FIG. 1 is a schematic view illustrating an example of staple fibers present in a plane parallel to a contact surface.

FIG. 2A is a schematic view illustrating an example of staple fibers present in a plane parallel to a contact surface. FIG. 2B is a schematic view illustrating another example of staple fibers present in a plane parallel to a contact surface.

FIG. 3A is a schematic view illustrating an exemplary rubber layer. FIG. 3B is a schematic view illustrating another exemplary rubber layer. FIG. 3C is a schematic view illustrating exemplary stacked rubber layers. FIG. 3D is a schematic view illustrating exemplary parallel rubber layers.

FIG. 4 is a schematic view illustrating the outline structure of silica rods (sepiolite).

### DESCRIPTION OF EMBODIMENTS

The pneumatic tire of the present invention includes a tread including a rubber layer formed from a rubber composition that includes: carbon black; silica; and staple fibers with an average width of 3 nm to 50 μm and an average length of 50 nm to 500 μm, the staple fibers in the rubber layer having an average orientation angle between the longitudinal direction of each staple fiber and the circumferential direction of the tire of 15° to 75°, and the staple fibers in the rubber layer including 35 to 100% of staple fibers each having an orientation angle between its longitudinal direction and the circumferential direction of the tire of 15° to 75°.

Staple fibers have the feature of being oriented in the extrusion direction. When such a feature is utilized to prepare a rubber composition including carbon black and silica together with specific staple fibers whose orientation is controlled to specific conditions for use in a tread, then it is possible to obtain a pneumatic tire that has improved handling stability while maintaining good fuel economy and tensile strength or even improving these properties.

The average orientation angle of the staple fibers in the rubber layer, between the longitudinal direction of each staple fiber and the circumferential direction of the tire herein refers to an average value of orientation angles between the circumferential direction of the tire and the longitudinal directions of the staple fibers in a plane of the rubber layer parallel to a contact surface (tread surface) which comes into contact with the road surface (for example, an average value calculated from orientation angles of 100 staple fibers in the longitudinal direction, measured using a transmission electron microscope).

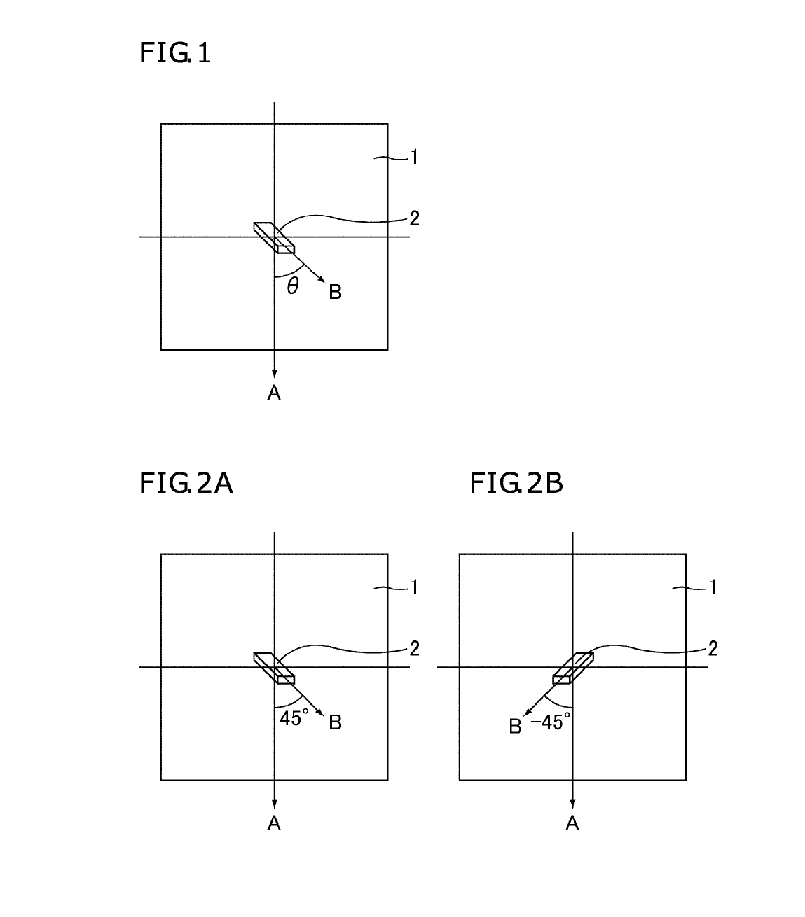

The circumferential direction of the tire refers to a direction along the circumference of the tire (i.e., direction A in FIG. 1).

The longitudinal direction refers to a direction along the long side of the principal surface (surface with the largest area in a plan view) of a staple fiber (i.e., direction B in FIG. 1).

The orientation angle refers to an angle between the longitudinal direction of a staple fiber and the circumferential direction of the tire (i.e., θ in FIG. 1).

Hereinafter, the outline of the method for calculating the orientation angle of a staple fiber is described referring to drawings.

First, a plane parallel to a contact surface is prepared from the rubber layer. In the case that the rubber layer forms the outer surface layer of the tread, the outer surface layer of the tread can be directly cut out and used. Alternatively, in the case that the rubber layer does not form the outer surface layer of the tread, the rubber layer can be cut so that the plane parallel to the contact surface appears.

Next, the plane 1 parallel to the contact surface is observed with a transmission electron microscope. One staple fiber 2 present in the plane 1 parallel to the contact surface is brought into focus. Once the direction along the long side of the principal surface of the staple fiber 2 (longitudinal direction; direction B in FIG. 1) is determined, the orientation angle (θ in FIG. 1) that is an angle between the longitudinal direction (direction B in FIG. 1) and the circumferential direction of the tire (direction A in FIG. 1) can be determined.

The average orientation angle in the rubber layer is 15° or larger, preferably 30° or larger, and more preferably 35° or larger. If the average orientation angle is smaller than 15°, the effects of such oriented staple fibers are small, failing to sufficiently improve handling stability. In addition, satisfactory fuel economy will not be achieved, either. The average orientation angle is 75° or smaller, preferably 60° or smaller, and more preferably 55° or smaller. If the average orientation angle is larger than 75°, the staple fibers are oriented nearly vertically to the circumferential direction of the tire, and the rubber stiffness required for the braking or traction of tires is reduced, failing to achieve satisfactory handling stability. In addition, the fuel economy and tensile strength are also reduced.

The average orientation angle can be determined by, for example, measuring the orientation angles of 100 staple fibers in the longitudinal direction with a transmission electron microscope, and calculating the average value of the orientation angles.

The ratio (orientation ratio) of staple fibers each having an orientation angle between its longitudinal direction and the circumferential direction of the tire of 15° to 75° to the total staple fibers in the rubber layer is 35% or higher, preferably 60% or higher, and more preferably 80% or higher. The ratio of lower than 35% tends to lead to reduced fuel economy and insufficient improvement of handling stability. The upper limit of the ratio is not particularly limited, and may be 100%, or 90% or lower.

The ratio can be determined by, for example, measuring the orientation angles of 100 staple fibers in the longitudinal direction with a transmission electron microscope, and calculating the ratio of staple fibers each having an orientation angle of 15° to 75°.

The rubber layer preferably has a ratio (E*ₐ/E*_{b}) of a complex elastic modulus E*ₐ in the circumferential direction of the tire to a complex elastic modulus E*_{b} in the radial direction of the tire of lower than 5.0, more preferably 3.0 or lower, and still more preferably 2.0 or lower. If the ratio is 5.0 or higher, the rubber tends to have a large difference in stiffness against strain in the compression direction and in the shear direction to limit the strain direction in which the rubber has stiffness, and therefore stiffness tends not be achieved on various road surfaces and on various vehicles, thereby failing to achieve satisfactory handling stability. The ratio is preferably 0.5 or higher, and more preferably 1.0 or higher. The ratio of lower than 0.5 tends not to result in satisfactory handling stability.

The ratio in the above range enables the rubber to have stiffness against strain both in the compression direction and the shear direction, which means that stiffness can be achieved on various road surfaces and on various vehicles, so that excellent handling stability is achieved.

The ratio E*ₐ/E*_{b} is measured by the method described in the later-described examples.

The rubber layer preferably has a thickness of 0.5 to 10 mm, and more preferably 1.5 to 8 mm. The thickness of the rubber layer in the range can lead to better achievement of the effects of the present invention.

The thickness of the rubber layer herein refers to an average value of thicknesses of the rubber layer in the direction normal to the outer surface located on the outside in the radial direction of the tire.

The present invention uses in a tread a rubber layer formed from a rubber composition that includes carbon black and silica together with specific staple fibers whose orientation is controlled to specific conditions.

Accordingly, the present invention provides a pneumatic tire that has improved handling stability while maintaining good fuel economy and tensile strength or even improving these properties.

The tread is only required to have the rubber layer mentioned above. For example, the tread may consist of the rubber layer alone, or may include the rubber layer and other rubber layer(s). The rubber layer may be a plurality of the rubber layers. In particular, use of a plurality of the rubber layers is preferred. In this case, the rubber layers are preferably combined so that the staple fiber orientation directions of the rubber layers are opposite to each other with respect to the circumferential direction of the tire. More preferably, the rubber layers to be combined have average orientation angles which are symmetrical about the axis of the circumferential direction of the tire. With such combination, a pneumatic tire having improved ring stiffness and excellent handling stability can be provided. The rubber layer is preferably formed continuously in the circumferential direction of the tire.

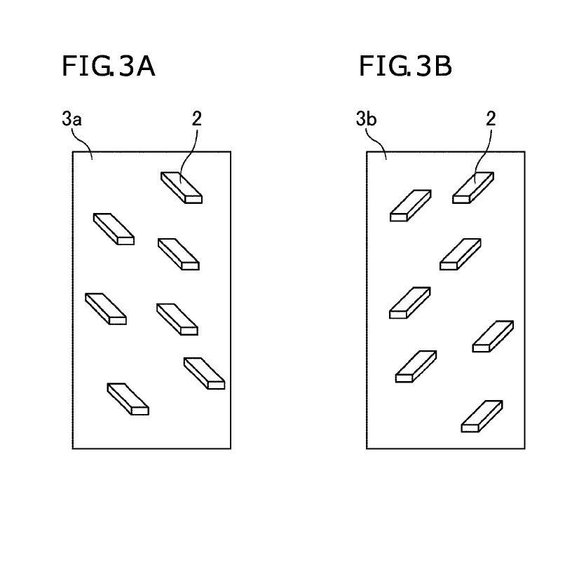

Here, the statement “the staple fiber orientation directions are opposite to each other with respect to the circumferential direction of the tire” means that, as illustrated with the staple fiber 2 in FIG. 2A and the staple fiber 2 in FIG. 2B, the staple fibers of the layers are oriented in directions opposite to each other with respect to the circumferential direction of the tire (direction A in FIG. 2). To clarify that the orientation directions are opposite to each other, the “minus (−)” sign is attached herein to a numerical value of orientation angle formed in the opposite direction.

Also, the “average orientation angles which are symmetrical about the axis of the circumferential direction of the tire” means that the staple fibers of the layers are oriented in directions opposite to each other with respect to the circumferential direction of the tire (direction A in FIG. 2), and the absolute values of the average orientation angles are substantially the same as each other. Here, being “substantially the same as each other” means that the difference between the absolute values of the average orientation angles is 3° or less.

Specific preferred examples of the tread include (I) a tread which is obtained by stacking a rubber layer A formed from the rubber composition and a rubber layer B formed from the rubber composition in the radial direction of the tire, and in which the staple fibers in the rubber layer A have an average orientation angle between the longitudinal direction of each staple fiber and the circumferential direction of the tire of 15° to 75°, and the staple fibers in the rubber layer B have an average orientation angle between the longitudinal direction of each staple fiber and the circumferential direction of the tire of −15° to −75°. Combination use of the rubber layers having anisotropy further improves the ring stiffness of the tire so as to provide a pneumatic tire with better handling stability. In this case, the tread may only include stacked rubber layers obtained by stacking the rubber layer A and the rubber layer B, or may include the stacked rubber layers and other rubber layer(s). Although the number of rubber layers to be stacked is not particularly limited, two rubber layers are preferably stacked.

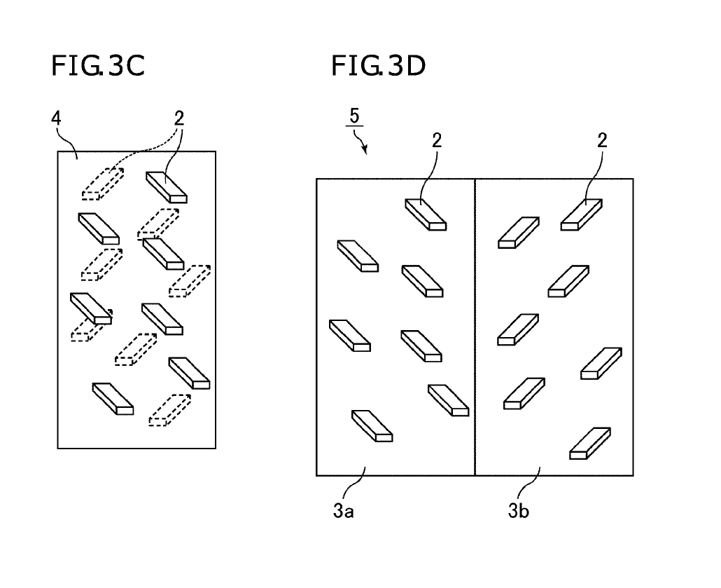

For the case (I), for example, the tread may include stacked rubber layers 4 (illustrated in FIG. 3C) obtained by stacking a rubber layer 3a (corresponding to the rubber layer A) illustrated in FIG. 3A and a rubber layer 3b (corresponding to the rubber layer B) illustrated in FIG. 3B in the radial direction of the tire. FIG. 3C illustrates the stacked rubber layers 4 obtained by stacking the rubber layer 3a illustrated in FIG. 3A on an outer side of the rubber layer 3b illustrated in FIG. 3B in the radial direction of the tire. The staple fibers 2 illustrated by the dotted line are staple fibers in the rubber layer 3b.

Regarding the absolute values of the average orientation angles, the ratios of staple fibers each having an orientation angle between its longitudinal direction and the circumferential direction of the tire of 15° to 75° (or −15° to −75°), and the ratios E*ₐ/E*_{b} of the rubber layers A and B, the respective preferred ranges are the same as mentioned earlier for the rubber layer.

Although the thickness of the rubber layer to be stacked is not particularly limited, the thickness per one rubber layer is preferably 0.5 mm or larger. Stacking rubber layers with a thickness of smaller than 0.5 mm is not preferred because it takes much time in production. The thickness per one rubber layer is preferably smaller than 3 mm. Stacking rubber layers with a thickness of 3 mm or larger may increase the distance between rubber layers, and therefore the effects of the rubber layer stack may not be produced satisfactorily.

Other specific preferred examples of the tread include (II) a tread which includes a rubber layer C formed from the rubber composition and a rubber layer D formed from the rubber composition, and in which the rubber layer C and the rubber layer D are arranged next to each other in the axis direction of the tire, the length of the rubber layer C in the axis direction of the tire constitutes 20 to 80% of the length of the tread in the axis direction of the tire, the staple fibers in the rubber layer C have an average orientation angle between the longitudinal direction of each staple fiber and the circumferential direction of the tire of 15° to 75°, and the staple fibers in the rubber layer D have an average orientation angle between the longitudinal direction of each staple fiber and the circumferential direction of the tire of −15° to −75°. Combination use of rubber layers having anisotropy further improves the ring hardness of the tire so as to provide a pneumatic tire with better handling stability. In this case, the tread may only include parallel rubber layers obtained by arranging the rubber layer C and the rubber layer D next to each other, or may include the parallel rubber layers and other rubber layer(s). Although the number of rubber layers to be arranged next to each other is not particularly limited, two rubber layers are preferably arranged next to each other.

For the case (II), for example, the tread may include parallel rubber layers 5 (illustrated in FIG. 3D) obtained by arranging a rubber layer 3a (corresponding to the rubber layer C) illustrated in FIG. 3A and a rubber layer 3b (corresponding to the rubber layer D) illustrated in FIG. 3B next to each other in the axis direction of the tire.

The length of the rubber layer C in the axis direction of the tire preferably constitutes 20% or higher, and more preferably 40% or higher, of the length of the tread in the axis direction of the tire. The length ratio of the rubber layer C is preferably 80% or lower, and more preferably 60% or lower. The length ratio in the range leads to better handling stability. The ratio of the length of the rubber layer D in the axis direction of the tire to the length of the tread in the axis direction of the tire is the same as for the rubber layer C.

Regarding the absolute values of the average orientation angles, the ratios of staple fibers each having an orientation angle between its longitudinal direction and the circumferential direction of the tire of 15° to 75° (or −15° to −75°), and the ratios E*ₐ/E*_{b} of the rubber layers C and D, the respective preferred ranges are the same as mentioned earlier for the rubber layer.

The thickness of the parallel rubber layers is not particularly limited, and is preferably 1.0 mm or larger. The thickness of smaller than 1.0 mm may not allow the staple fibers to sufficiently improve the rubber stiffness, thereby failing to achieve satisfactory handling stability. The thickness of the parallel rubber layers is preferably smaller than 6 mm. The thickness of 6 mm or larger leads to increased surface area at the interface between the rubbers, which may sometimes cause interfacial separation when the tire is used under high severity conditions, such as a light truck tire.

Each of the stacked rubber layers (I) and the parallel rubber layers (II) may be used alone, or both may be used together. The parallel rubber layers (II), in particular, are preferably used in combination with the stacked rubber layers (I) because they may undergo interfacial separation depending on the use conditions.

Next, the rubber composition for forming the rubber layer which is included in the tread used in the pneumatic tire of the present invention is described.

Examples of usable rubbers for the rubber component include diene rubbers such as natural rubber (NR), isoprene rubber (IR), butadiene rubber (BR), styrene butadiene rubber (SBR), acrylonitrile butadiene rubber (NBR), chloroprene rubber (CR), butyl rubber (IIR), and styrene-isoprene-butadiene copolymer rubber (SIBR). For achievement of fuel economy, tensile strength, and handling stability in a balanced manner, NR, BR, and SBR are preferred among these, and SBR is more preferred. Combination use of NR and SBR, combination use of BR and SBR, and combination use of NR, BR, and SBR are also preferred, and combination use of BR and SBR is more preferred.

Examples of SBR include, but are not limited to, emulsion-polymerized styrene butadiene rubber (E-SBR) and solution-polymerized styrene butadiene rubber (S-SBR).

The styrene content of SBR is preferably 10% by mass or more, more preferably 25% by mass or more, and still more preferably 30% by mass or more. The styrene content is preferably 50% by mass or less, and more preferably 45% by mass or less. The styrene content in the range contributes to favorable fuel economy, wet grip performance, and tensile strength.

The styrene content can be calculated by H¹-NMR measurement.

The amount of SBR based on 100% by mass of the rubber component is preferably 50% by mass or more, more preferably 60% by mass or more, for achievement of fuel economy and abrasion resistance in a balanced manner. The amount of SBR may be 100% by mass, and is preferably 90% by mass or less, and more preferably 80% by mass or less. The amount of SBR in the range contributes to favorable fuel economy, tensile strength, and handling stability.

Examples of BR include, but are not limited to, BR with high cis content, such as BR1220 produced by Zeon Corporation, and BR130B and BR150B produced by Ube Industries, Ltd.; and BR containing syndiotactic polybutadiene crystals, such as VCR412 and VCR617 produced by Ube Industries, Ltd. Especially for favorable abrasion resistance, the cis content of BR is preferably 90% by mass or more.

The amount of BR based on 100% by mass of the rubber component is preferably 10% by mass or more, more preferably 20% by mass or more, for achievement of fuel economy and abrasion resistance in a balanced manner. The amount of BR is preferably 50% by mass or less, and more preferably 40% by mass or less. The amount of BR in the range contributes to favorable fuel economy, tensile strength, and handling stability.

In the present invention, staple fibers with an average width of 3 nm to 50 μm and an average length of 50 nm to 500 μm are used. The staple fibers are not particularly limited as long as the average width and average length are in the respective ranges. Examples of the staple fibers include silica rods, coal pitch based carbon fibers, polyester fibers, polyvinylalcohol fibers, polyamide fibers, cotton fibers, silk fibers, hemp fibers, wool fibers, cellulose fibers, aromatic polyamide fibers, fully aromatic polyester fibers, poly(para-phenylene benzobisoxazole) fibers, carbon fibers, polyketone fibers, and basalt fibers. Particularly, silica rods are preferred for reduction in E*ₐ/E*_{b} and therefore achievement of favorable handling ability, and for achievement of excellent fuel economy and tensile strength.

Silica rods are an inorganic material (silica) which has, differently from usual silica having a spherical shape, a rod-like or needle-like shape and has silanol groups on the surface. Examples of the silica rods include sepiolite, palygorskite, attapulgite, xylotile, loughlinite, falcondoite, and imogolite. Particularly preferred among these are sepiolite and attapulgite, because they have a small amount of impurities and a large amount of silanol groups. Herein, where the term “silica” appears alone, it should be understood that it refers to spherical silica, unless otherwise specified.

The silica rods each have silanol groups on the surface. Accordingly, when the composition contains a silane coupling agent, then the silica rods can be bonded to rubber molecules via the silane coupling agent, which thus allows the effects of silica rods (e.g. reinforcing effect) to be produced satisfactorily.

For the silica rods, materials obtained by defibration of a sepiolite mineral [Mg₈Si₁₂O₃₀(OH)₄(H₂O)₄.8 (H₂O)] which is a fibrous material are suitable. The sepiolite mineral forms a talc-like 2:1 structure in which three Si—O tetrahedra are linked to form an Si—O tetrahedral sheet parallel to the fiber direction, and the sheets are joined by octahedrally coordinated magnesium ions. These structures adhere to each other to form a fiber bundle, which can form an aggregate.

The aggregate can be divided (defibrated) through an industrial process such as pulverization (grinding) or chemical modification (see, for example, EP 170299, which is hereby incorporated by reference), so that fibers with a diameter in the order of nanometers, i.e., delaminated (defibrated) silica rods (sepiolite) can be prepared. In the present invention, although the method for defibration of the sepiolite mineral is not particularly limited, the sepiolite mineral is preferably defibrated without substantially destroying the shape of the fibrous silica rods (sepiolite). Examples of such a defibration method include wet grinding (e.g., methods described in EP 170299, JP H05-97488 A, and EP 85200094-4, all of which are hereby incorporated by reference).

A specific example of the wet grinding method is described. First, a moisture-containing sepiolite mineral is ground until the particle size is 2 mm or smaller. To the ground product is added water to a solids concentration of the resulting suspension of 5 to 25%. A dispersant (e.g., alkali salt of hexametaphosphoric acid) is then added to the suspension. Next, the suspension is stirred for 5 to 15 minutes using a stirrer having high shearing force. Here, the following stirring regime is used: stirring for 2 to 7 minutes at a low rotational speed, and then stirring for 2 to 8 minutes at a high rotational speed. Then, the resulting supernatant is separated by decantation or centrifugation, whereby silica rods (sepiolite) can be obtained without substantially destroying the shape of the fibrous silica rods.

The sepiolite herein encompasses attapulgite (also known as palygorskite). Attapulgite is structurally and chemically almost the same as sepiolite, except that attapulgite has a slightly smaller unit cell (shorter fiber length).

The staple fibers (preferably silica rods) have an average width of 3 nm or larger, preferably 5 nm or larger. The average width of smaller than 3 nm is likely to increase the surface area, thereby leading to poor dispersion of the fibers in rubber. The silica rods have an average width of 50 μm or smaller, preferably 10 μm or smaller, more preferably 1 μm or smaller, still more preferably 100 nm or smaller, particularly preferably 35 nm or smaller, and most preferably 30 nm or smaller. The average width of larger than 50 μm is likely to decrease the aspect ratio, failing to achieve satisfactory fuel economy.

The staple fibers (preferably silica rods) have an average length of 50 nm or longer, preferably 100 nm or longer, and more preferably 300 nm or longer. The average length of shorter than 50 nm is likely to decrease the aspect ratio, failing to achieve satisfactory fuel economy. The silica rods have an average length of 500 μm or shorter, preferably 100 μm or shorter, more preferably 50 μm or shorter, still more preferably 10 μm or shorter, particularly preferably 5 μm or shorter, further preferably 3 μm or shorter, and most preferably 2 μm or shorter. The average length of longer than 500 μm is likely to cause the fibers to form a fracture initiation site, leading to poor tensile strength.

The staple fibers (preferably silica rods) preferably have an aspect ratio (average length/average width) of 2 or more, and more preferably 5 or more. The aspect ratio of less than 2 is not likely to lead to satisfactory fuel economy. The upper limit of the aspect ratio of the silica rods is not particularly limited, and a larger aspect ratio within the scope of the shape mentioned above, for example 2000, is preferred.

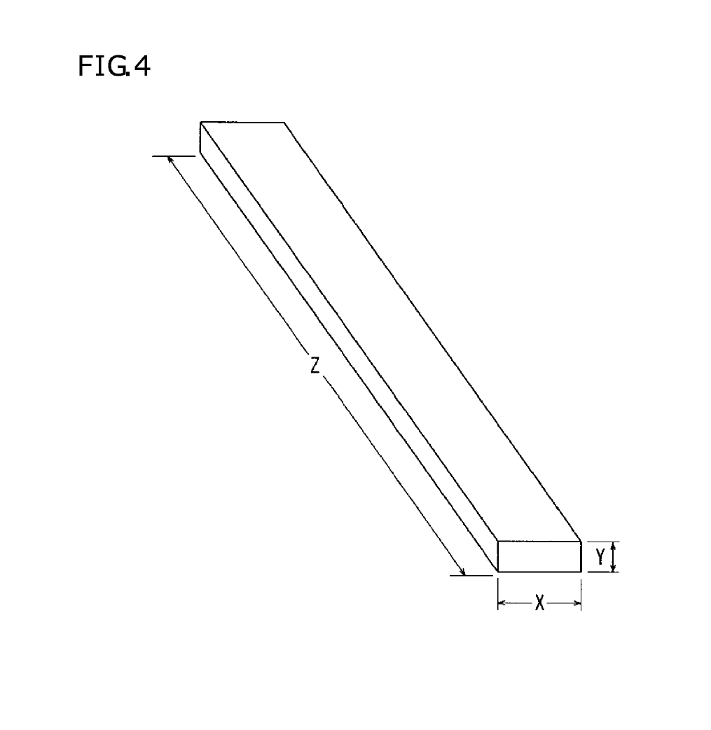

FIG. 4 is a schematic view illustrating the outline structure of silica rods (sepiolite). As illustrated in FIG. 4, silica rods (sepiolite) have a needle-like or elongated fibrous (rod-like) shape. The width, thickness and length of sepiolite correspond to X, Y and Z in FIG. 4, respectively. In other words, the width (X) of sepiolite is the length of the short side of the principal surface (surface with the largest area in a plan view), the thickness (Y) of sepiolite is the length in the direction normal to the principal surface, and the length (Z) of sepiolite is the length of the long side of the principal surface.

The average width of the staple fibers (preferably silica rods) herein refers to an average value of Xs of silica rods measured with a transmission electron microscope (e.g., an average value calculated from measured Xs of 100 silica rods). The average length of the staple fibers (preferably silica rods) herein refers to an average value of Zs of silica rods measured with a transmission electron microscope (e.g., an average value calculated from measured Zs of 100 silica rods).

The amount of the staple fibers (preferably silica rods) is preferably 0.5 parts by mass or more, more preferably 2 parts by mass or more, and still more preferably 5 parts by mass or more, per 100per 100 parts by mass of the rubber component. An amount of less than 0.5 parts by mass may not lead to achievement of satisfactory effects of the staple fibers (preferably silica rods). The amount is preferably 50 parts by mass or less, and more preferably 30 parts by mass or less, per 100 parts by mass of the rubber component. An amount of more than 50 parts by mass is likely to lead to poor processability.

The present invention employs silica (spherical silica). Use of the silica provides favorable reinforcement, and excellent tensile strength and handling stability. In addition, excellent fuel economy will be achieved. Examples of the silica include, but are not limited to, dry silica (anhydrous silicic acid) and wet silica (hydrous silicic acid). Wet silica is preferred because such silica contains a large number of silanol groups. One kind of silica may be used alone, or two or more kinds of silica may be used in combination.

The nitrogen adsorption specific surface area (N₂SA) of the silica is preferably 50 m²/g or larger, and more preferably 80 m²/g or larger. The N₂SA of smaller than 50 m²/g is likely to lead to a small reinforcing effect, failing to achieve satisfactory tensile strength and handling stability. The N₂SA is preferably 300 m²/g or smaller, more preferably 250 m²/g or smaller, and still more preferably 200 m²/g or smaller. The N₂SA of larger than 300 m²/g is likely to lead to poor dispersion of silica, and therefore to increase hysteresis loss and decrease fuel economy. In addition, the tensile strength is then likely to decrease.

Herein, the N₂SA of silica is a value determined by the BET method in accordance with ASTM D3037-93.

In the rubber composition, the amount of the silica is preferably 10 parts by mass or more, and more preferably 20 parts by mass or more, per 100 parts by mass of the rubber component. An amount of less than 10 parts by mass is likely to have a small reinforcing effect, failing to achieve satisfactory tensile strength and handling stability. In addition, favorable fuel economy is then not likely to be achieved. The amount is preferably 150 parts by mass or less, more preferably 100 parts by mass or less, still more preferably 70 parts by mass or less, and particularly preferably 50 parts by mass or less, per 100 parts by mass of the rubber component. An amount of more than 150 parts by mass is likely to result in poor processability and dispersibility, decreasing tensile strength and fuel economy.

The total amount of the staple fibers (preferably silica rods) and silica is preferably 10 parts by mass or more, more preferably 20 parts by mass or more, and still more preferably 30 parts by mass or more, per 100 parts by mass of the rubber component. A total amount of less than 10 parts by mass is not likely to achieve satisfactory fuel economy, tensile strength, and handling stability. The total amount is preferably 200 parts by mass or less, more preferably 100 parts by mass or less, still more preferably 80 parts by mass or less, and particularly preferably 60 parts by mass or less, per 100 parts by mass of the rubber component. A total amount of more than 200 parts by mass is likely to decrease the kneading processability.

The rubber composition preferably includes a silane coupling agent together with the silica rods and silica.

Examples of the silane coupling agent include sulfide, mercapto, vinyl, amino, glycidoxy, nitro, and chloro silane coupling agents. Among these, bis(3-triethoxysilylpropyl)disulfide is preferred in terms of the effect of improving reinforcement and the like.

The amount of the silane coupling agent is preferably 1 part by mass or more, and more preferably 4 parts by mass or more, per 100 parts by mass in total of the staple fibers (preferably silica rods) and silica. An amount of less than 1 part by mass may have an unsatisfactory coupling effect, leading to decrease in fuel economy, tensile strength, and handling stability. The amount is preferably 15 parts by mass or less, and more preferably 12 parts by mass or less, per 100 parts by mass in total of the staple fibers (preferably silica rods) and silica. An amount of more than 15 parts by mass may result in remaining excess silane coupling agent, leading to decrease of the processability and tensile strength of the resulting rubber composition.

The rubber composition includes carbon black. This provides favorable reinforcement and thus contributes to excellent tensile strength and handling stability.

The nitrogen adsorption specific area (N₂SA) of carbon black is preferably 60 m²/g or larger, and more preferably 90 m²/g or larger. The N₂SA of smaller than 60 m²/g may lead to unsatisfactory tensile strength and handling stability. The N₂SA is preferably 200 m²/g or smaller, more preferably 160 m²/g or smaller, and still more preferably 130 m²/g or smaller. The N₂SA of larger than 200 m²/g may lead to poor dispersion of carbon black and therefore poor processability and unsatisfactory tensile strength and fuel economy.

The N₂SA of carbon black is determined in accordance with JIS K 6217-2:2001.

The dibutyl phthalate oil absorption (DBP) of carbon black is preferably 50 ml/100 g or more, and more preferably 90 ml/100 g or more. The DBP of less than 50 ml/100 g may lead to unsatisfactory tensile strength and handling stability. The DBP of carbon black is preferably 200 ml/100 g or less, and more preferably 135 ml/100 g or less. The DBP of more than 200 ml/100 g may lead to poor dispersion of carbon black and therefore poor processability and unsatisfactory tensile strength and fuel economy.

The DBP of carbon black is measured based on JIS K 6217-4:2001.

The amount of carbon black is preferably 5 parts by mass or more, more preferably 10 parts by mass or more, and still more preferably 20 parts by mass or more, per 100 parts by mass of the rubber component. An amount of smaller than 5 parts by mass may not achieve satisfactory tensile strength and handling stability. The amount is preferably 150 parts by mass or less, more preferably 100 parts by mass or less, and still more preferably 50 parts by mass or less, per 100 parts by mass of the rubber component. An amount of more than 150 parts by mass may lead to poor dispersion of carbon black and therefore poor processability and unsatisfactory tensile strength and fuel economy.

The rubber composition preferably includes a polymer mixture which is obtained by modifying a polymer of a conjugated diene compound and/or an aromatic vinyl compound by a compound containing an ester group and/or a carboxyl group, and which has a weight average molecular weight of 1.0×10³ to 1.0×10⁵.

The polymer mixture is obtained by reacting a part or the whole of the polymer of a conjugated diene compound and/or an aromatic vinyl compound with the above compound;

is a mixture of polymers which includes a modified polymer that is a reaction product with the above compound, and optionally the non-modified polymer that has not been reacted with the above compound; and has a specific weight average molecular weight. By using such a component together with the silica, carbon black, and specific staple fibers and also controlling the orientation of the staple fibers to specific conditions, it is possible to provide a pneumatic tire that has better rubber hardness and more improved handling stability while maintaining good fuel economy and tensile strength.

The polymer of a conjugated diene compound and/or an aromatic vinyl compound is preferably a copolymer of a conjugated diene compound and an aromatic vinyl compound or a homopolymer of a conjugated diene compound, and more preferably a copolymer of a conjugated diene compound and an aromatic vinyl compound, for achievement of favorable fuel economy, tensile strength, and handling stability.

Examples of the conjugated diene compound include 1,3-butadiene, isoprene, 1,3-pentadiene, 2,3-dimethylbutadiene, 2-phenyl-1,3-butadiene, and 1,3-hexadiene. Each of these may be used alone, or two or more of these may be used in combination. In terms of practical aspects including availability of monomers, 1,3-butadiene and isoprene are preferred, and 1,3-butadiene is more preferred among the examples.

Examples of the aromatic vinyl compound include styrene, α-methylstyrene, 1-vinylnaphthalene, 3-vinyltoluene, ethylvinylbenzene, divinylbenzene, 4-cyclohexylstyrene, and 2,4,6-trimethylstyrene. Each of these may be used alone, or two or more of these may be used in combination. In terms of practical aspects including availability of monomers, styrene is particularly preferred among the examples.

Here, 1,3-butadiene is used to produce a butadiene homopolymer, or styrene is used to produce a styrene homopolymer, or 1,3-butadiene and styrene are used to produce a styrene-butadiene copolymer.

The polymer of a conjugated diene compound and/or an aromatic vinyl compound is preferably a styrene homopolymer, a butadiene homopolymer, or a styrene-butadiene copolymer, more preferably a butadiene homopolymer or a styrene-butadiene copolymer, and still more preferably a styrene-butadiene copolymer.

The polymer mixture can be synthesized by, for example, polymerizing a conjugated diene compound and/or an aromatic vinyl compound and optionally hydrogenating the obtained polymer, and then reacting the produced polymer with a compound containing an ester group and/or a carboxyl group. More specifically, the polymer mixture can be synthesized by the method mentioned below.

The method for polymerizing a conjugated diene compound and/or an aromatic vinyl compound is not particularly limited and may be any conventionally known method. Specific examples of the method include a method involving anionic polymerization of a conjugated diene compound and/or an aromatic vinyl compound in an organic solvent inert to the reaction, such as a hydrocarbon solvent (e.g. aliphatic, alicyclic, or aromatic hydrocarbon compound), in the presence of an organolithium compound as a polymerization initiator and optionally a randomizer.

The hydrocarbon solvent is not particularly limited, and is preferably a C3 to C8 hydrocarbon solvent. Examples of the solvent include propane, n-butane, isobutane, n-pentane, isopentane, n-hexane, cyclohexane, propene, 1-butene, isobutene, trans-2-butene, cis-2-butene, 1-pentene, 2-pentene, 1-hexene, 2-hexene, benzene, toluene, xylene, and ethylbenzene.

The organolithium compound is preferably one containing a C2 to C20 alkyl group. Examples thereof include ethyllithium, n-propyllithium, isopropyllithium, n-butyllithium, sec-butyllithium, tert-butyllithium, tert-octyllithium, n-decyllithium, phenyllithium, 2-naphthyllithium, 2-butylphenyllithium, 4-phenylbutyllithium, cyclohexyllithium, cyclopentyllithium, and reaction products of diisopropenylbenzene and butyllithium. Among these, n-butyllithium or sec-butyllithium is preferred in terms of availability, safety and the like.

A randomizer is a compound that, for example, functions to control the microstructure of the conjugated diene moiety in a copolymer (e.g., increase of 1,2-bond in butadiene units), or to control the compositional distribution of monomer units in a copolymer (e.g., randomization of butadiene units and styrene units in a butadiene-styrene copolymer). The randomizer is not particularly limited, and may be any conventionally known compound generally used as a randomizer. Examples of the compound include ethers and tertiary amines, such as dimethoxybenzene, tetrahydrofuran, dimethoxyethane, diethylene glycol dibutyl ether, diethylene glycol dimethyl ether, bistetrahydrofuryl propane, triethylamine, pyridine, N-methylmorpholine, N,N,N′,N′-tetramethylethylenediamine, and 1,2-dipiperidinoethane. Also, potassium salts including potassium t-amylate and potassium t-butoxide, and sodium salts including sodium t-amylate may be used.

The amount of the randomizer used is preferably 0.01 molar equivalents or more, and more preferably 0.05 molar equivalents or more, per mole of the polymerization initiator. The addition of less than 0.01 molar equivalents of the randomizer is likely to have a small effect, making randomization difficult. The amount of the randomizer used is preferably 1000 molar equivalents or less, and more preferably 500 molar equivalents or less, per mole of the polymerization initiator. More than 1000 molar equivalents of the randomizer is likely to greatly change the reaction rate of monomers, which rather tends to make randomization difficult.

The polymerization method is not particularly limited, and may be any of solution polymerization, gas phase polymerization, and bulk polymerization. Particularly in terms of the degree of freedom of polymer design, processability and the like, solution polymerization is preferred. The polymerization mode may be any of a batch mode and a continuous mode.

In the case of employing solution polymerization, the monomer concentration (total concentration of monomers including the conjugated diene compound and aromatic vinyl compound) in the solution is preferably 5% by mass or higher, and more preferably 10% by mass or higher. The monomer concentration in the solution of lower than 5% by mass is likely to result in a small amount of copolymer obtained, thereby increasing the cost. The monomer concentration in the solution is preferably 50% by mass or lower, and more preferably 30% by mass or lower. The monomer concentration in the solution of higher than 50% by mass is likely to cause the solution viscosity to be so high that stirring may be difficult, making polymerization difficult.

The polymer used to form the polymer mixture in the present invention may be a hydrogenated polymer. In this case, a polymer obtained through the polymerization reaction is further hydrogenated to prepare a hydrogenated polymer, which is then modified with the compound, whereby a hydrogenated polymer mixture of interest can be synthesized.

Hydrogenation can be performed by a known hydrogenation method, such as a method of treating a polymer with a known hydrogenation catalyst (e.g., homogeneous hydrogenation catalyst, heterogeneous hydrogenation catalyst) under a hydrogen pressure of 1 to 100 atm to hydrogenate the polymer.

The resulting polymer is modified with a compound containing an ester group and/or a carboxyl group to prepare a polymer mixture. Here, the ester group is represented by —O—C(═O)—R or —C(═O)—O—R (R: monovalent saturated or unsaturated hydrocarbon group), and the carboxyl group is represented by —C(═O)—O—H.

The compound (modifier) containing an ester group and/or a carboxyl group may be any compound that contains at least one of these functional groups. Examples thereof include carboxylic anhydrides such as succinic anhydride, butylsuccinic anhydride, 1,2-cyclohexanedicarboxylic anhydride, decylsuccinic anhydride, dodecylsuccinic anhydride, hexadecylsuccinic anhydride, 4-methylcyclohexane-1,2-dicarboxylic anhydride, octadecylsuccinic anhydride, n-octylsuccinic anhydride, n-tetradecylsuccinic anhydride, glutaric anhydride, 1,1-cyclopentanediacetic anhydride, 3,3-dimethylglutaric anhydride, 2,2-dimethylglutaric anhydride,. 3-methylglutaric anhydride, 4-tert-butylphthalic anhydride, 4-methylphthalic anhydride, 3-methylphthalic anhydride, and maleic anhydride; methyl bromoacetate, ethyl bromoacetate, i-propyl bromoacetate, t-butyl bromoacetate, benzyl bromoacetate, butyl 2-methylbromoacetate, t-butyl 2-methylbromoacetate, ethyl 2,2-dimethylbromoacetate, t-butyl 2,2-dimethylbromoacetate, ethyl 2-diethylbromoacetate, methyl 2-phenylbromoacetate, methyl 3-bromopropanoate, ethyl 3-bromopropanoate, methyl 2-methyl-3-bromopropanoate, methyl 4-bromobutanoate, ethyl 4-bromobutanoate, methyl 2-methyl-4-chlorobutanoate, ethyl 6-bromohexanoate, ethyl 5-bromopentanoate, methyl cyanoformate, methyl chloroformate, ethyl chloroformate, i-propyl chloroformate, i-butyl chloroformate, t-butyl chloroformate, pentyl chloroformate, hexyl chloroformate, heptyl chloroformate, octyl chloroformate, decyl chloroformate, dodecyl chloroformate, hexadecyl chloroformate, phenyl chloroformate, benzyl chloroformate, t-butyl acrylate, methyl acrylate, ethyl acrylate, acrylic acid, methacrylic acid, itaconic acid, oxalic acid, malonic acid, succinic acid, glutaric acid, adipic acid, azelaic acid, sebacic acid, maleic acid, fumaric acid, and citraconic acid. Among these, in terms of favorable fuel economy, tensile strength, and handling stability, t-butyl acrylate, methyl cyanoformate, methyl acrylate, and carboxylic anhydrides such as 4-methylcyclohexane-1,2-dicarboxylic anhydride and maleic anhydride are preferred, carboxylic anhydrides are more preferred, and maleic anhydride is still more preferred.

The modification method using a modifier may be any method such as a method of bringing a polymer and a modifier into contact with each other. More specifically, the polymer and the compound can be reacted with each other to prepare a polymer mixture containing a modified polymer, by any of the following methods, for example: a method (1) of adding the compound to the solution of the polymer with an active terminal produced through the anionic polymerization (without quenching), and stirring the mixture at a predetermined temperature for a certain period of time; a method (2) of adding the compound after quenching, and then stirring the mixture at a predetermined temperature for a certain period of time; and a method (3) of once terminating (quenching) the reaction in the solution of the polymer with an active terminal produced through the anionic polymerization to give the unmodified polymer, treating the polymer again with a reagent such as a radical initiator in a hydrocarbon solvent, adding the certain modifier to the polymer, and stirring the resulting mixture at a predetermined temperature for a certain period of time.

In the modification reaction according to the method (1), the amount of the compound is preferably 0.001 parts by mass or more, more preferably 1 part by mass or more, whereas it is preferably 200 parts by mass or less, more preferably 50 parts by mass or less, and still more preferably 10 parts by mass or less, per 100 parts by mass of the polymer, in terms of favorable modification.

The temperature and time for the modification reaction in the method (1) can be appropriately set, and are typically 0 to 50° C. (preferably 20 to 40° C.) and 5 minutes to 6 hours, respectively. The stirring method is not particularly limited and may be any known method.

Typically, in order to terminate the polymerization reaction after modification, an additive such as water, alcohol and acid is added. Furthermore, a known antioxidant may optionally be added. With the method (1), a polymer mixture containing a terminally modified polymer can be prepared.

The method of adding the compound after quenching in the method (2) may be, for example, a method of dissolving a polymer that is produced through the anionic polymerization and then subjected to quenching, in a randomizer and optionally a solvent such as an organic solvent to prepare a solution, and then adding an organolithium compound and the compound to the solution. The polymer may be a commercially available polymer. With the method (2), a polymer mixture containing a backbone-modified polymer can be prepared.

The organic solvent, randomizer, and organolithium compound for the method (2) are preferably the same as those described above.

The amount of the randomizer used in the method (2) is preferably 0.01 molar equivalents or more, and more preferably 0.05 molar equivalents or more, whereas it is preferably 1000 molar equivalents or less, and more preferably 500 molar equivalents or less, per mole of the organolithium compound.

The amount of the organolithium compound used in the method (2) is preferably 0.00001 mol or more, and more preferably 0.0001 mol or more, whereas it is preferably 0.1 mol or less, and more preferably 0.01 mol or less, per gram of the polymer.

The amount of the compound, and the temperature and time for the modification reaction in the method (2) can be appropriately set, and are preferably the same as those in the method (1).

The method of terminating the reaction at the active terminal in the method (3) is not particularly limited and may be a method of adding an additive such as water, alcohol and acid. The hydrocarbon solvent may be the same as used in the polymerization. The radical initiator may be a compound such as azo compounds (e.g., 2,2′-azobis(isobutyronitrile) (AIBN)) and organolithium compounds described above. With the method (3), a polymer mixture containing a backbone-modified polymer can be prepared.

The amount of the radical initiator used in the method (3) is preferably 0.1 parts by mass or more, and more preferably 1 part by mass or more, whereas it is preferably 200 parts by mass or less, and more preferably 30 parts by mass or less, per 100 parts by mass of the polymer, in terms of favorable modification.

The amount of the modifier used in the method (3) is preferably 0.001 parts by mass or more, more preferably 0.5 parts by mass or more, and still more preferably 1 part by mass or more, whereas it is preferably 200 parts by mass or less, more preferably 50 parts by mass or less, and still more preferably 10 parts by mass or less, per 100 parts by mass of the polymer, in terms of favorable modification.

The temperature and time for the modification reaction. in the method (3) can be appropriately set, and are typically 0 to 80° C. (preferably 40 to 70° C.) and 5 minutes to 6 hours, respectively. The stirring method is not particularly limited and may be any known method. Typically, in order to terminate the polymerization reaction after modification (stirring), an additive such as water, alcohol, and acid is added. Furthermore, a known antioxidant may optionally be added.

Examples of the polymer mixture obtained as described above include a polymer mixture containing a modified polymer containing a modifying group represented by formula (1) below which is derived from the compound containing an ester group and/or a carboxyl group; and a polymer mixture containing a multimer (e.g., dimer, trimer) of the modified polymer. The formula (1) is:

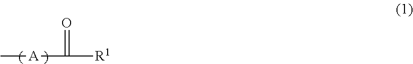

wherein A represents a divalent saturated or unsaturated hydrocarbon group; R¹ represents OR⁴ or a group represented by formula (2) below; and R⁴ represents a hydrogen atom or a monovalent saturated or unsaturated hydrocarbon group. The formula (2) is:

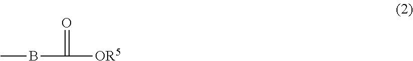

wherein B represents a divalent saturated or unsaturated hydrocarbon group, and R⁵ represents a hydrogen atom or a monovalent saturated or unsaturated hydrocarbon group.

The symbol A may be any divalent saturated or unsaturated hydrocarbon group, including linear, branched, or cyclic alkylene groups, alkenylene groups, and arylene groups. Among these, for excellent fuel economy, tensile strength, and rubber hardness (handling stability), groups represented by the following formula (3) are preferred:

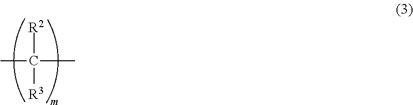

wherein m represents an integer of 0 to 6, and R² and R³ are the same as or different from each other, each representing a hydrogen atom, a C1 or C2 hydrocarbon group, or an aryl group.

The symbol m representing an integer of 0 to 6 is preferably an integer of 0 to 2.

Examples of the C1 or C2 hydrocarbon group for R² and R³ include methyl and ethyl. Examples of the aryl group for R² and R³ include phenyl and benzyl. R² and R³ are each preferably a hydrogen atom.

The modifying group represented by the above formula (1) may or may not include the divalent saturated or unsaturated hydrocarbon group represented by A.

The monovalent saturated or unsaturated hydrocarbon group for R⁴ is not particularly limited, and may be a group such as linear, branched, or cyclic alkyl groups, alkenyl groups, and aryl groups. In particular, C1 to 016 hydrocarbon groups are preferred, and examples of such groups include alkyl groups such as methyl, ethyl, propyl, butyl, pentyl, hexyl, heptyl, octyl, decyl, dodecyl, and hexadecyl; and aryl groups such as phenyl and benzyl. R⁴ is preferably a C1 to C16 alkyl group, and more preferably a C1 to C5 alkyl group.

The symbol B may be any divalent saturated or unsaturated hydrocarbon group, including hydrocarbon groups as mentioned for A. In particular, groups represented by any of formulas (4) to (7) shown below are preferred, groups represented by the formula (5) or (7) are more preferred, and groups represented by the formula (5) are still more preferred.

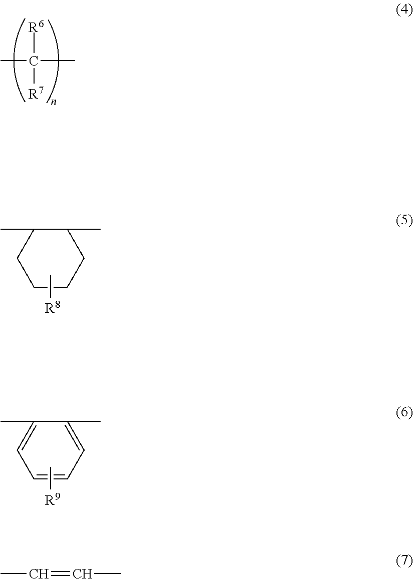

In the formulas, n represents an integer of 2 or 3; R⁶ and R⁷ are the same as or different from each other, each representing a hydrogen atom or a C1 to C18 hydrocarbon group; R⁸ represents a hydrogen atom or a methyl group; and R⁹ represents a hydrogen atom or a C1 to C4 hydrocarbon group.

Examples of the C1 to C18 hydrocarbon group for R⁶ and R⁷ include alkyl groups such as methyl, ethyl, propyl, butyl, pentyl, hexyl, heptyl, octyl, decyl, dodecyl, and hexadecyl; and aryl groups such as phenyl and benzyl.

R⁸ is preferably a methyl group.

Examples of the C1 to C4 hydrocarbon group for R⁹ include methyl, ethyl, propyl, and butyl.

The monovalent saturated or unsaturated hydrocarbon group for R⁵ is not particularly limited, and examples thereof include hydrocarbon groups as mentioned for R⁴, such as C1 to C6 hydrocarbon groups (e.g. methyl, ethyl, propyl, butyl, pentyl, hexyl). R⁵ is preferably a hydrogen atom.

The polymer mixture obtained as above preferably contains at least 0.1 modifying groups described above on average per molecule of the polymer used to form the mixture.

The average number of modifying groups (modifying group content) per molecule of the polymer herein is determined by the method described in the examples below.

The polymer mixture has a weight average molecular weight (Mw) of 1.0×10³ or more, preferably 2.0×10³ or more, and still more preferably 4.0×10³ or more. An Mw of less than 1.0×10³ is likely to give a large hysteresis loss which makes it difficult to achieve satisfactory fuel economy, and also likely to lead to reduced tensile strength and handling stability. The Mw is 1.0×10⁵ or less, preferably 5.0×10⁴ or less, more preferably 1.0×10⁴ or less, and still more preferably 6.0×10³ or less. An Mw of more than 1.0×10⁵ may lead to poor processability. The weight average molecular weight (Mw) herein is measured by the method described in the examples below.

The polymer mixture preferably has a viscosity (cps.) at 25° C. of 1.0×10⁴ or higher, more preferably 1.2×10⁴ or higher. The viscosity of lower than 1.0×10⁴ is likely to fail to secure satisfactory viscosity properties of the rubber composition, thereby leading to decrease in wet grip performance. The viscosity is preferably 8.0×10⁵ or lower, more preferably 2.0×10⁵ or lower, still more preferably 8.0×10⁴ or lower, and particularly preferably 3.0×10⁴ or lower. The viscosity of higher than 8.0×10⁵ is likely to increase the Mooney viscosity of the rubber composition, leading to greatly poor processability (kneading processability, extrusion processability).

The viscosity at 25° C. herein is measured by the method described in the examples below.

The polymer mixture (preferably a styrene-butadiene copolymer in the polymer mixture) preferably has a styrene content of 5% by mass or more, more preferably 10% by mass or more. The styrene content of less than 5% by mass may not lead to satisfactory fuel economy, processability, tensile strength, and wet grip performance. The styrene content is preferably 45% by mass or less, and more preferably 35% by mass or less. The styrene content of more than 45% by mass is likely to lead to poor fuel economy, processability, tensile strength, and wet grip performance.

The styrene content herein is measured by the method described in the examples below.

The polymer mixture preferably has a vinyl content of 80 mol % or less, more preferably 75 mol % or less, based on 100 mol % of conjugated diene units, in terms of fuel economy. The vinyl content is preferably 20 mol % or more, and more preferably 25 mol % or more, in terms of wet grip performance.

The vinyl content is determined by infrared spectroscopic analysis, from the absorption intensity around 910 cm⁻¹ which is the absorption peak of vinyl group.

The rubber composition preferably includes 0.5 parts by mass or more, more preferably 1 part by mass or more, and still more preferably 3 parts by mass or more, of the polymer mixture per 100 parts by mass of the rubber component. An amount of less than 0.5 parts by mass may not sufficiently improve processability, tensile strength, handling stability, fuel economy, and wet grip performance. The amount is preferably 50 parts by mass or less, more preferably 20 parts by mass or less, still more preferably 15 parts by mass or less, and particularly preferably 8 parts by mass or less, per 100 parts by mass of the rubber component. An amount of more than 50 parts by mass is likely to decrease tensile strength.

It should be noted that the rubber component of the rubber composition does not encompass the polymer mixture.

The rubber composition may appropriately include, in addition to the above components, additives generally used for the preparation of a rubber composition, such as reinforcing filler (e.g. clay), oil, various antioxidants, stearic acid, zinc oxide, wax, vulcanizing agents, and vulcanization accelerators.

The rubber composition preferably includes 1 part by mass or more, more preferably 3 parts by mass or more, of oil per 100 parts by mass of the rubber component. An amount of less than 1 part by mass is not likely to allow the rubber composition to come easily together during kneading, thereby leading to poor processability. The amount of oil is preferably 20 parts by mass or less, and more preferably 15 parts by mass or less, per 100 parts by mass of the rubber component. An amount of more than 20 parts by mass is likely to decrease the rubber hardness, reducing handling stability. In addition, the tensile strength is then likely to decrease.

The rubber composition can be prepared by a usual method. That is, the rubber composition can be prepared by, for example, a method of kneading the components mentioned above by a known kneading device generally used in the rubber industry, such as a Banbury mixer, kneader, or open roll mill, and then vulcanizing the kneaded mixture.

The pneumatic tire of the present invention can be prepared by a usual method using the rubber composition. That is, the rubber composition containing the components mentioned above is extruded into a rubber sheet before vulcanization. The obtained rubber sheet is optionally further rolled with a roller to improve the orientation ratio. Taking advantage of the fact the staple fibers have the feature of being oriented in the extrusion direction or rolling direction, the obtained rubber sheet is cut at a predetermined angle to give a rubber layer in which the orientation of the staple fibers is controlled to specific conditions. Next, the obtained rubber layer is formed into stacked rubber layers or parallel rubber layers according to the need. The rubber layers are then processed into the shape of a tread, and molded together with other tire components by a usual method in a tire building machine to form an unvulcanized tire. The unvulcanized tire is heat-pressed in a vulcanizer, whereby a tire is obtained.

The pneumatic tire of the present invention is suitable for passenger cars, trucks and buses, two-wheel vehicles, racing vehicles and the like. In particular, the pneumatic tire is more suitable for passenger cars.

### EXAMPLES

Hereinafter, the present invention will be described in more detail based on examples which, however, are not intended to limit the scope of the present invention.

The chemical agents used for synthesis and polymerization in the production examples are listed below. The chemical agents were purified by usual methods when needed.

n-Hexane: product of Kanto Chemical Co., Inc.

1,3-Butadiene: product of TAKACHIHO CHEMICAL INDUSTRIAL CO., LTD.

Styrene: product of Kanto Chemical Co., Inc.

Tetramethylethylenediamine: product of Kanto Chemical Co., Inc.

1.6 M Solution of n-butyllithium in hexane: product of Kanto Chemical Co., Inc.

2,6-Di-t-butyl-p-cresol: product of Ouchi Shinko Chemical Industrial Co., Ltd.

Modifier (1): maleic anhydride, product of Tokyo Chemical Industry Co., Ltd.

Modifier (2): methyl acrylate, product of Tokyo Chemical Industry Co., Ltd.

AIBN: 2,2′-azobis(isobutyronitrile)

### Production Example 1

### Synthesis of Styrene-Butadiene Copolymers (1) to (5)

After the air in a 3-L autoclave equipped with a stirrer was fully replaced with nitrogen, the autoclave was charged with n-hexane, 1,3-butadiene, styrene, and tetramethylethylenediamine in amounts shown in Table 1, and the temperature in the autoclave was set to 25° C. To the mixture was added a 1.6 M solution of n-butyllithium in hexane, and the resulting mixture was polymerized at an elevated temperature (30° C.) for 60 minutes. After the conversion ratio of monomers was confirmed to be 99%, 1.5 g of 2,6-di-t-butyl-p-cresol was added as an antioxidant. In this way, styrene-butadiene copolymers (1) to (5) were obtained.

### Production Example 2

### Synthesis of Modified Styrene-Butadiene Copolymers (1) to (5)

A flask was charged with each of the styrene-butadiene copolymers (1) to (5), n-hexane, and AIBN in amounts shown in Table 2, and the temperature in the flask was set to 60° C. Next, after addition of a modifier to the mixture and one-hour stirring of the mixture, the resulting reaction solution was treated with methanol, and mixed with 1.5 g of 2,6-di-t-butyl-p-cresol as an antioxidant. In this way, modified styrene-butadiene copolymers (1) to (5) were obtained.

The obtained styrene-butadiene copolymers (1) to (5) and modified styrene-butadiene copolymers (1) to (5) (polymer mixtures) were evaluated as described below. Tables 1 and 2 show the results.

### (Viscosity at 25° C.)

The viscosity was measured at 25° C. by a BROOKFIELD DV II-viscometer (BROOKFIELD ENGINEERING LABORATORIES, INC.) with a Helipath T-C bar spindle at 10 rpm.

### (Measurement of Styrene Content)

H¹-NMR measurement was performed at 25° C. using a JEOL JNM-A 400NMR device. The ratio of the amount of phenyl protons from the styrene units at 6.5 to 7.2 ppm to the amount of vinyl protons from the butadiene units at 4.9 to 5.4 ppm was determined from the obtained spectrum. From the ratio, the styrene content of the copolymer or the styrene content of the polymer mixture was determined.

### (Measurement of Weight Average Molecular Weight (Mw))

The weight average molecular weight Mw of the copolymer or polymer mixture was determined by a gel permeation chromatograph (GPC) (GPC-8000 series produced by Tosoh Corporation; detector: differential refractometer, column: TSKGEL SUPERMULTIPORE HZ-M produced by Tosoh Corporation) and calibrated with polystyrene standards.

### (Determination of Modifying Group Content Per Molecule: Titration Test)

An amount of 0.1 g of KOH was weighed to prepare 100 ml of a NeOH solution. Next, 0.5 g of the sample was weighed out and dissolved in 30 ml of toluene to prepare a modified polymer solution. One drop of phenolphthalein was added to the modified polymer solution, and then the KOH solution was added dropwise to the resulting solution to carry out a titration test. The acid concentration determined by calculation was taken as the modification rate.

TABLE 1

| | | | Styrene-butadiene copolymer | | | | |
|---|---|---|---|---|---|---|---|
| | | | (1) | (2) | (3) | (4) | (5) |
| Charged | Styrene | g | 31 | 18 | 12 | 12 | 18 |
| amount | 1,3-Butadiene | g | 46 | 55 | 68 | 68 | 55 |
| | Tetramethylethylenediamine | g | 1.6 | 1.6 | 1.2 | 0.6 | 1.6 |
| | 1.6M Solution of n-butyllithium in hexane | mL | 23 | 23 | 16.6 | 8.4 | 230 |
| | n-Hexane | mL | 1500 | 1500 | 1500 | 1500 | 500 |
| Evaluation | Styrene content | % by mass | 40.3 | 24.7 | 15 | 14.8 | 24.7 |
| | Weight average molecular weight (Mw) | — | 5000 | 5000 | 5000 | 15000 | 500 |

TABLE 2

| | | | Modified styrene-butadiene copolymer | | | | |
|---|---|---|---|---|---|---|---|
| | | | (1) | (2) | (3) | (4) | (5) |
| Charged | Styrene-butadiene copolymer (1) | g | 100 | — | — | — | — |
| amount | Styrene-butadiene copolymer (2) | g | — | 100 | 100 | — | — |
| | Styrene-butadiene copolymer (3) | g | — | — | — | 100 | — |
| | Styrene-butadiene copolymer (4) | g | — | — | — | — | 100 |
| | Styrene-butadiene copolymer (5) | g | — | — | — | — | — |
| | AIBN | g | 4.92 | 4.92 | 4.92 | 4.92 | 4.92 |
| | n-Hexane | mL | 500 | 500 | 500 | 500 | 500 |
| | Modifier (1) | g | 2.06 | 2.06 | — | 2.06 | 2.06 |
| | Modifier (2) | g | — | — | 1.76 | — | — |
| Evaluation | Viscosity | cps. | 17000 | 15000 | 14000 | 15000 | 190000 |
| | Styrene content | % by mass | 40.3 | 24.7 | 24.7 | 15 | 14.8 |
| | Weight average molecualr weight (Mw) | — | 5000 | 5000 | 5000 | 5000 | 15000 |
| | Modifying group content per molecule | Number of | 1 | 1 | 1 | 1 | 1 |
| | | groups | | | | | |

### Examples and Comparative Examples

Hereinafter, the chemical agents used in the examples and comparative examples are listed.

BR: BR150B (cis content: 97% by mass), product of Ube Industries, Ltd.

SBR: SBR755B (styrene content: 40% by mass; vinyl content: 40% by mass; 37.5 parts by mass of oil is contained per 100 parts by mass of rubber component), product of JSR Corporation

Carbon black: N220 (DBP: 115 m1/100 g, N₂SA: 110 m²/g), product of Cabot Japan K.K.

Silica: ZEOSIL 1165MP (N₂SA: 160 m²/g), product of Rhodia

Coal-pitch based carbon fiber: K6371T (chopped fiber, average fiber diameter: 11 μm, average fiber length: 6.3 mm), product of Mitsubishi Plastics, Inc.

Silica rods: PANGEL AD (length: 200 to 2000 nm, width: 5 to 30 nm, length/width: 8 to 400, wet-ground article of sepiolite mineral), product of TOLSA

Silane coupling agent: silane coupling agent Si75, product of Degussa

Oil: X-140, product of Japan Energy Corporation

Zinc oxide: zinc oxide #1, product of Mitsui Mining & Smelting Co., Ltd.

Stearic acid: stearic acid “Tsubaki”, product of NOF Corporation

Antioxidant: Antigene 6C (N-(1,3-dimethylbutyl)-N′-phenyl-p-phenylenediamine), product of Sumitomo Chemical Co., Ltd.

Sulfur: sulfur powder, product of Tsurumi Chemical Industry Co., Ltd.

Vulcanization accelerator (1): Nocceler NS (N-tert-butyl-2-benzothiazolylsulfenamide), product of Ouchi Shinko Chemical Industrial Co., Ltd.

Vulcanization accelerator (2): Nocceler D (N,N′-diphenylguanidine), product of Ouchi Shinko Chemical Industrial Co., Ltd.

Modified styrene-butadiene copolymers (1) to (5):

### Production Example 2

The materials in amounts shown in Table 3, other than the sulfur and vulcanization accelerators, were mixed and kneaded using a 1.7 L Banbury mixer at 150° C. for three minutes, so that a kneaded mixture was obtained. Thereafter, the sulfur and the vulcanization accelerators were added to the kneaded mixture, and they were kneaded at 80° C. for five minutes by an open roll mill, whereby an unvulcanized rubber composition was obtained. A rubber sheet with a rubber thickness of 1.5 mm was prepared from the unvulcanized rubber composition obtained using the open roll mill. The rubber sheet was cut at predetermined angles relative to the rolling direction to prepare different rubber sheets (unvulcanized rubber layers) with differently oriented staple fibers.

Next, the obtained rubber sheets (unvulcanized rubber layers) were molded into the shape of a tread and assembled with other tire components to form an unvulcanized tire. The unvulcanized tire was press-vulcanized at 170° C. for 10 minutes to prepare a test tire (size 195/65R15). For controlling the orientation ratio, the number of extrusions and the number of rollings were appropriately varied.

In Table 3, in examples with the column “stacked structure” having the symbol “o”, each test tire was prepared under the same conditions as described above, except that a rubber sheet with a rubber thickness of 0.75 mm was prepared from the unvulcanized rubber composition obtained using the open roll mill; and then the two rubber sheets which were different from each other only in that the average orientation angles of the rubber sheets had positive and negative signs, respectively (only the respective orientation directions of the staple fibers relative to the circumferential direction of the tire were different, and the absolute values of the average orientation angles, the ratios of staple fibers each having an orientation angle between its longitudinal direction and the circumferential direction of the tire of 15° to 75° (or −15° to −75°), and the ratios E*ₐ/E*_{b} were the same) were stacked to form stacked rubber layers, which were then molded into the shape of a tread. For example, in Example 1, a rubber sheet having a structure shown in Example 1 was obtained; and then the rubber sheet and the reversed rubber sheet (rubber sheet differing from the former rubber sheet only in that the average orientation angle had a different sign (positive or negative)) were stacked to form stacked rubber layers, which were then molded into the shape of a tread.

In examples with the column “parallel structure” having the symbol “o”, each test tire was prepared under the same conditions as described above, except that a rubber sheet with a rubber thickness of 1.5 mm was prepared from the unvulcanized rubber composition obtained using the open roll mill; and then the two rubber sheets which were different only in that the average orientation angles of the rubber sheets had positive and negative signs, respectively (only the respective orientation directions of the staple fibers relative to the circumferential direction of the tire were different, and the absolute values of the average orientation angles, the ratios of staple fibers each having an orientation angle between its longitudinal direction and the circumferential direction of the tire of 15° to 75° (−15° to −75°), and the ratios E*ₐ/E*_{b} were the same) were arranged next to each other in the axis direction of the tire to form parallel rubber layers, which were then molded into the shape of a tread (such that the length of each rubber sheet in the axis direction of the tire constituted 50% of the length of the tread in the axis direction of the tire). For example, in Example 11, a rubber sheet having a structure shown in Example 11 was obtained; and then the rubber sheet and the reversed rubber sheet (rubber sheet differing from the former rubber sheet only in that the average orientation angle had a different sign (positive or negative)) were arranged next to each other in the axis direction of the tire to form parallel rubber layers, which were then molded into the shape of a tread (such that the length of each rubber sheet in the axis direction of the tire constituted 50% of the length of the tread in the axis direction of the tire).

In examples with the column ‘stacked structure” not having the symbol “o”, the thickness of the rubber layer was 1.5 mm. In examples with the column “stacked structure” having the symbol “o”, the thickness of each rubber layer to be stacked (i.e., per one rubber layer) was 0.75 mm (to give stacked rubber layers with a total thickness of 1.5 mm).

The obtained test tires and rubber vulcanizates cut out from the treads of the test tires were evaluated as described below. Table 3 shows the results. In examples with the column “stacked structure” having the symbol “o”, only the upper layer of the stacked rubber layers was cut out from the tread of each test tire and used as the rubber vulcanizate. In examples with the column “parallel structure” having the symbol “o”, only one layer of the parallel rubber layers was cut out from the tread of each test tire and used as the rubber vulcanizate.

(E*ₐ/E*_{b})

Strip specimens were prepared from the obtained rubber vulcanizate, and the complex elastic modulus E*ₐ of the rubber vulcanizate in the circumferential direction of the tire and the complex elastic modulus E*_{b} of the rubber vulcanizate in the radial direction of the tire were measured with a viscoelasticity spectrometer produced by Iwamoto Seisakusho Co., Ltd., under the conditions: temperature 70° C., frequency 10 Hz, initial strain 10%, and dynamic strain ±2%. Then, the ratio E*ₐ/E*_{b} was calculated.

### (Average Orientation Angle)

The orientation angles of 100 staple fibers in the longitudinal direction relative to the circumferential direction of the tire were measured in the obtained rubber vulcanizate by a transmission electron microscope. The average value of the orientation angles was calculated and used as the average orientation angle.

### (Orientation Ratio)

The orientation angles of 100 staple fibers in the longitudinal direction relative to the circumferential direction of the tire were measured in the obtained rubber vulcanizate by a transmission electron microscope. The ratio of staple fibers each having an orientation angle between its longitudinal direction and the circumferential direction of the tire of 15° to 75° was taken as the ratio (orientation ratio) of staple fibers each having an orientation angle between its longitudinal direction and the circumferential direction of the tire of 15° to 75° to the total staple fibers in the rubber layer.

### (Fuel Economy)

The rolling resistance of the test tire was measured in a rolling resistance testing machine by running the tire under the conditions: rim 15×6 JJ, internal pressure 230 kPa, load 3.43 kN, and velocity 80 km/h. The rolling resistance in Comparative Example 1 was taken as 100, and the rolling resistance of each test tire was then expressed as an index calculated from the following formula. A larger value indicates better fuel economy.

(Rolling resistance index)=(rolling resistance in Comparative Example 1)/(rolling resistance of each composition)×100

### (Rubber Hardness)

In accordance with JIS K6253-1 “Rubber, vulcanized or thermoplastic—Determination of hardness,” the hardness of the rubber vulcanizate was determined by a type A durometer. The resulting value is shown as an index relative to the value in Comparative Example 1 taken as 100. A larger value indicates higher rubber hardness.

### (Tensile Strength)

In accordance with JIS K6251, tensile testing was performed to measure elongation at break (EB)% by punching out, using a No. 3 dumbbell-shaped mold, a specimen from the tread of the test tire such that the tensile direction of the specimen was parallel to the circumferential direction of the tire. The resulting value is shown as an index relative to the value in Comparative Example 1 taken as 100. A larger index indicates greater tensile strength, which in turn indicates that the tire has excellent durability.

### (Handling Stability)

The test tire was mounted on every wheel of an FF car (engine size: 2000 cc) made in Japan. The car was driven on a test course of Sumitomo Rubber Industries, Ltd. in Nayoro, Hokkaido, Japan, and the handling stability was evaluated by feeling of the driver. On a scale of 1 to 10, with 10 being the best, the evaluation was made relative to Comparative Example 1 which was given an evaluation of 6. A higher number indicates better handling stability.

TABLE 3

| | | Comparative Example | | | | | | Example | | |
|---|---|---|---|---|---|---|---|---|---|---|
| | | 1 | 2 | 3 | 4 | 5 | 6 | 1 | 2 | 3 |
| Formulation | BR | 30 | 30 | 30 | 30 | 30 | 30 | 30 | 30 | 30 |
| (parts by mass) | SBR | 96.25 | 96.25 | 96.25 | 96.25 | 96.25 | 96.25 | 96.25 | 96.25 | 96.25 |
| | Carbon black | 30 | 30 | 30 | 30 | 30 | 30 | 30 | 30 | 30 |
| | Silica | 30 | 30 | 30 | 30 | 30 | 30 | 30 | 30 | 30 |
| | Silica rods | — | 10 | — | 10 | 10 | 10 | 10 | 10 | 10 |
| | Coal-pitch based carbon fiber | — | — | 10 | — | — | — | — | — | — |
| | Silane coupling agent | 2.4 | 3.2 | 3.2 | 3.2 | 3.2 | 3.2 | 3.2 | 3.2 | 3.2 |
| | Oil | — | 10 | 10 | 10 | 10 | 10 | 10 | 10 | 10 |
| | Zinc oxide | 3 | 3 | 3 | 3 | 3 | 3 | 3 | 3 | 3 |
| | Stearic acid | 2 | 2 | 2 | 2 | 2 | 2 | 2 | 2 | 2 |
| | Antioxidant | 2 | 2 | 2 | 2 | 2 | 2 | 2 | 2 | 2 |
| | Sulfur | 2 | 2 | 2 | 2 | 2 | 2 | 2 | 2 | 2 |
| | Vulcanization accelerator (1) | 2 | 2 | 2 | 2 | 2 | 2 | 2 | 2 | 2 |
| | Vulcanization accelerator (2) | 2 | 2 | 2 | 2 | 2 | 2 | 2 | 2 | 2 |
| | Modified styrene-butadiene | — | — | — | — | — | — | — | — | — |
| | copolymer (1) | | | | | | | | | |
| | Modified styrene-butadiene | — | — | — | — | — | — | — | — | — |
| | copolymer (2) | | | | | | | | | |
| | Modified styrene-butadiene | — | — | — | — | — | — | — | — | — |
| | copolymer (3) | | | | | | | | | |
| | Modified styrene-butadiene | — | — | — | — | — | — | — | — | — |
| | copolymer (4) | | | | | | | | | |
| | Modified styrene-butadiene | — | — | — | — | — | — | — | — | — |
| | copolymer (5) | | | | | | | | | |
| Structure | E*ₐ/E*_{b} | 1.1 | 1.8 | 5.3 | 0.7 | 1.6 | 1.1 | 1.5 | 1.3 | 1.1 |
| | Average orientation angle (°) | 5 | 5 | 5 | 85 | 40 | 60 | 30 | 45 | 60 |
| | Orientation ratio (%) | 98 | 94 | 96 | 89 | 34 | 31 | 85 | 88 | 87 |
| Stacked structure | | — | — | — | — | — | — | ◯ | ◯ | ◯ |
| Parallel structure | | — | — | — | — | — | — | — | — | — |
| Evaluation | Fuel economy | 100 | 103 | 91 | 96 | 98 | 97 | 101 | 103 | 101 |
| results | Rubber hardness | 100 | 105 | 110 | 105 | 105 | 105 | 105 | 105 | 105 |
| | Tensile strength | 100 | 103 | 95 | 97 | 101 | 100 | 105 | 105 | 105 |
| | Handling stability | 6 | 5.75 | 6.25 | 5.75 | 6 | 6 | 6.25 | 6.5 | 6.25 |
| | | Example | | | | | | | | |
| | | 4 | 5 | 6 | 7 | 8 | 9 | 10 | 11 | 12 |
| Formulation | BR | 30 | 30 | 30 | 30 | 30 | 30 | 30 | 30 | 30 |
| (parts by mass) | SBR | 96.25 | 96.25 | 96.25 | 96.25 | 96.25 | 96.25 | 96.25 | 96.25 | 96.25 |
| | Carbon black | 30 | 30 | 30 | 30 | 30 | 30 | 30 | 30 | 30 |
| | Silica | 30 | 30 | 30 | 30 | 30 | 30 | 30 | 30 | 30 |
| | Silica rods | 10 | 10 | 10 | 10 | 10 | 10 | 10 | 10 | 10 |
| | Coal-pitch based carbon fiber | — | — | — | — | — | — | — | — | — |
| | Silane coupling agent | 3.2 | 3.2 | 3.2 | 3.2 | 3.2 | 3.2 | 3.2 | 3.2 | 3.2 |
| | Oil | 5 | 5 | 5 | 5 | 10 | 10 | 10 | 10 | 10 |
| | Zinc oxide | 3 | 3 | 3 | 3 | 3 | 3 | 3 | 3 | 3 |
| | Stearic acid | 2 | 2 | 2 | 2 | 2 | 2 | 2 | 2 | 2 |
| | Antioxidant | 2 | 2 | 2 | 2 | 2 | 2 | 2 | 2 | 2 |
| | Sulfur | 2 | 2 | 2 | 2 | 2 | 2 | 2 | 2 | 2 |
| | Vulcanization accelerator (1) | 2 | 2 | 2 | 2 | 2 | 2 | 2 | 2 | 2 |
| | Vulcanization accelerator (2) | 2 | 2 | 2 | 2 | 2 | 2 | 2 | 2 | 2 |
| | Modified styrene-butadiene | 5 | — | — | — | — | — | — | — | — |
| | copolymer (1) | | | | | | | | | |
| | Modified styrene-butadiene | — | 5 | — | — | — | — | — | — | — |
| | copolymer (2) | | | | | | | | | |
| | Modified styrene-butadiene | — | — | 5 | — | — | — | — | — | — |
| | copolymer (3) | | | | | | | | | |
| | Modified styrene-butadiene | — | — | — | 5 | — | — | — | — | — |
| | copolymer (4) | | | | | | | | | |
| | Modified styrene-butadiene | — | — | — | — | 5 | — | — | — | — |
| | copolymer (5) | | | | | | | | | |
| Structure | E*ₐ/E*_{b} | 1.3 | 1.3 | 1.3 | 1.3 | 1.3 | 1.1 | 1.1 | 1.5 | 1.3 |
| | Average orientation angle (°) | 45 | 45 | 45 | 45 | 45 | 45 | 45 | 30 | 45 |
| | Orientation ratio (%) | 86 | 87 | 88 | 88 | 86 | 46 | 62 | 85 | 88 |
| Stacked structure | | ◯ | ◯ | ◯ | ◯ | ◯ | ◯ | ◯ | — | — |
| Parallel structure | | — | — | — | — | — | — | — | ◯ | ◯ |
| Evaluation | Fuel economy | 102 | 103 | 101 | 101 | 97 | 101 | 102 | 101 | 101 |
| results | Rubber hardness | 112 | 109 | 108 | 107 | 119 | 102 | 104 | 105 | 105 |
| | Tensile strength | 103 | 102 | 102 | 100 | 100 | 102 | 102 | 105 | 105 |
| | Handling stability | 6.75 | 6.75 | 6.5 | 6.5 | 7 | 6.25 | 6.25 | 6.25 | 6.25 |

Table 3 shows that the handling stability was improved while good fuel economy and tensile strength were maintained or these properties were improved in the examples in which the tire included a tread including a rubber layer formed from a rubber composition that contained carbon black, silica, and staple fibers with an average width of 3 nm to 50 μm and an average length of 50 nm to 500 μm, the staple fibers in the rubber layer had an average orientation angle between the longitudinal direction of each staple fiber and the circumferential direction of the tire of 15° to 75°, and the staple fibers in the rubber layer included 35 to 100% of staple fibers each having an orientation angle between its longitudinal direction and the circumferential direction of the tire of 15° to 75°.

### REFERENCE SIGNS LIST

1 Plane parallel to contact surface
2 Staple fiber
3 (3a, 3b) Rubber layer
4 Stacked rubber layers
5 Parallel rubber layers

1. A pneumatic tire, comprising a tread comprising a rubber layer formed from a rubber composition that comprises:
carbon black;
silica; and
staple fibers with an average width of 3 nm to 50 μm and an average length of 50 nm to 500 μm,
the staple fibers in the rubber layer having an average orientation angle between the longitudinal direction of each staple fiber and the circumferential direction of the tire of 15° to 75°, and
the staple fibers in the rubber layer comprising 35 to 100% of staple fibers each having an orientation angle between its longitudinal direction and the circumferential direction of the tire of 15° to 75°.

2. The pneumatic tire according to claim 1, wherein the staple fibers are silica rods.

3. The pneumatic tire according to claim 1,
wherein the staple fibers are obtained by defibration of a sepiolite mineral.

4. The pneumatic tire according to claim 1,
wherein the staple fibers have a ratio of the average length to the average width of 5 to 2000.

5. The pneumatic tire according to claim 1,
wherein the rubber composition comprises, per 100 parts by mass of a rubber component, 5 to 150 parts by mass of the carbon black, 10 to 150 parts by mass of the silica, and 0.5 to 50 parts by mass of the staple fibers.

6. The pneumatic tire according to claim 1,
wherein the tread is obtained by stacking a rubber layer A formed from the rubber composition and a rubber layer B formed from the rubber composition,
the staple fibers in the rubber layer A have an average orientation angle between the longitudinal direction of each staple fiber and the circumferential direction of the tire of 15° to 75°, and
the staple fibers in the rubber layer B have an average orientation angle between the longitudinal direction of each staple fiber and the circumferential direction of the tire of −15° to −75°.

7. The pneumatic tire according to claim 1,
wherein the tread comprises a rubber layer C formed from the rubber composition and a rubber layer D formed from the rubber composition,
the rubber layer C and the rubber layer D are arranged next to each other in the axis direction of the tire,
the length of the rubber layer C in the axis direction of the tire constitutes 20 to 80% of the length of the tread in the axis direction of the tire,
the staple fibers in the rubber layer C have an average orientation angle between the longitudinal direction of each staple fiber and the circumferential direction of the tire of 15° to 75°, and
the staple fibers in the rubber layer D have an average orientation angle between the longitudinal direction of each staple fiber and the circumferential direction of the tire of −15° to −75°.

8. The pneumatic tire according to claim 1,
wherein the rubber layer has a ratio (E*ₐ/E*_{b}) of a complex elastic modulus E*ₐ in the circumferential direction of the tire to a complex elastic modulus E*_{b} in the radial direction of the tire of lower than 5.0.

9. The pneumatic tire according to claim 1,
wherein the rubber composition comprises a polymer mixture obtained by modifying a polymer of at least one of a conjugated diene compound and an aromatic vinyl compound by a compound containing at least one of an ester group and a carboxyl group, and
the polymer mixture has a weight average molecular weight of 1.0×10³ to 1.0×10⁵.

10. The pneumatic tire according to claim 9,
wherein the polymer mixture contains a modified polymer containing a modifying group represented by the following formula (1): 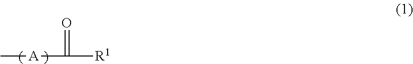
wherein A represents a divalent saturated or unsaturated hydrocarbon group; R¹ represents OR⁴ or a group represented by formula (2) below; and R⁴ represents a hydrogen atom or a monovalent saturated or unsaturated hydrocarbon group,
the formula (2) being: 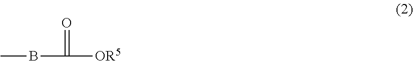
wherein B represents a divalent saturated or unsaturated hydrocarbon group, and R⁵ represents a hydrogen atom or a monovalent saturated or unsaturated hydrocarbon group.

11. The pneumatic tire according to claim 10,
wherein the A is represented by the following formula (3) : 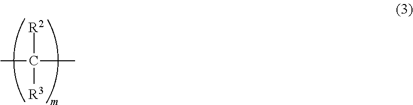
wherein m represents an integer of 0 to 6, and R² and R³ are the same as or different from each other, each representing a hydrogen atom, a C1 or C2 hydrocarbon group, or an aryl group, and
the B is represented by any one of the following formulas (4) to (7): 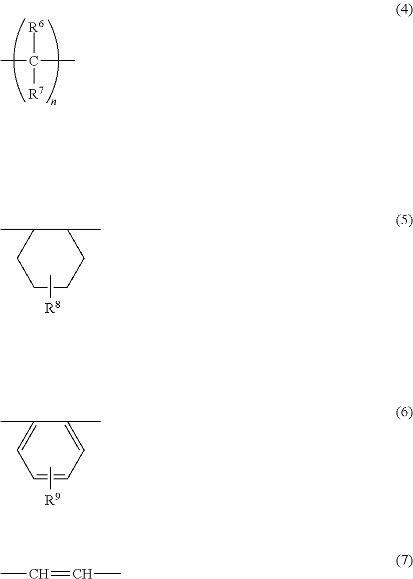
wherein n represents an integer of 2 or 3; R⁶ and R⁷ are the same as or different from each other, each representing a hydrogen atom or a C1 to C18 hydrocarbon group; R⁸ represents a hydrogen atom or a methyl group; and R⁸ represents a hydrogen atom or a C1 to C4 hydrocarbon group.

12. The pneumatic tire according to claim 9,
wherein the polymer mixture has a viscosity at 25° C. of 1.0×10⁴ to 8.0×105.

13. The pneumatic tire according to claim 9,
wherein the polymer used to form the polymer mixture is a styrene homopolymer, a butadiene homopolymer, or a styrene-butadiene copolymer.

14. The pneumatic tire according to claim 9,
wherein the compound containing at least one of an ester group and a carboxyl group is a carboxylic anhydride.
